(19) United States
(12) Patent Application Publication
(10) Pub. No.: US 2016/0236212 A1
(43) Pub. Date: Aug. 18, 2016

(54) SHOWERHEAD WITH AUDIO ASSEMBLY

(71) Applicant: Delta Faucet Company, Indianapolis, IN (US)

(72) Inventors: Paul V. Patton, Indianapolis, IN (US); Mercedita Andrew, Indianapolis, IN (US); Todd Andrew Huffington, Avon, IN (US)

(21) Appl. No.: 15/043,876

(22) Filed: Feb. 15, 2016

Related U.S. Application Data
(60) Provisional application No. 62/117,947, filed on Feb. 18, 2015.

(51) Int. Cl. B05B 1/18; B05B 1/12; H04R 1/02

(52) U.S. Cl. CPC B05B 1/185; H04R 1/028; B05B 1/12; H04R 2420/07

(57) ABSTRACT

A showerhead including a diverter assembly, a pivoting sprayface supported by a housing and having a plurality of spray openings, the plurality of spray openings including a first set of spray openings defining a first spray pattern and a second set of spray openings defining a second spray pattern, a first waterway fluidly connecting the diverter to the first set of spray openings of the sprayface, a second waterway fluidly connecting the diverter to the second set of spray openings of the sprayface, an audio device releasably coupled to the housing, wherein the diverter is configured to switch between the first and the second spray patterns by directing fluid to one of the first waterway and the second waterway.

### CROSS-REFERENCE TO RELATED APPLICATION

This application claims priority to U.S. Provisional Patent Application Ser. No. 62/117,947, filed Feb. 18, 2015, the disclosure of which is expressly incorporated herein by reference.

### BACKGROUND AND SUMMARY OF THE DISCLOSURE

The present invention relates generally to a showerhead and, more particularly, to an audio assembly removably coupled to a showerhead, illustratively with a pivoting sprayface.

Showerheads providing a variety of different functions, or modes of operation, are well known in the art. The present invention provides a showerhead system that includes a showerhead assembly removably coupled to an audio assembly. The audio assembly may connect wirelessly with another device when attached to the showerhead or when placed on a surface, for example, a table. Additionally, the showerhead assembly illustratively includes the functionality of a plurality of waterways having a single waterway or a dual waterway for fluidly connecting a water supply to a sprayface.

According to an illustrative embodiment of the present disclosure, a showerhead includes a diverter assembly, a housing supporting a pivoting sprayface having a plurality of spray openings, the plurality of spray openings including a first set of spray openings defining a first spray pattern and a second set of spray openings defining a second spray pattern, a first waterway fluidly connecting the diverter to the first set of spray openings of the sprayface, and a second waterway fluidly connecting the diverter to the second set of spray openings of the sprayface. An audio device is releasably coupled to the housing. The diverter assembly is configured to switch between the first and the second spray patterns by directing fluid to one of the first waterway and the second waterway.

According to another illustrative embodiment of the present disclosure, a showerhead includes an audio assembly having at least one speaker, a plurality of control buttons configured to adjust at least one of a plurality of audio features, a battery, and at least one release mechanism. The showerhead further includes a showerhead body, wherein the at least one release mechanism is configured to selectively detach and attach the at least one audio assembly to the showerhead body.

According to a further illustrative embodiment, a showerhead system includes an audio assembly having at least one speaker, a plurality of control buttons configured to adjust at least one of a plurality of audio features, a battery, and at least one release mechanism. The showerhead system further includes a showerhead body having a diverter assembly, a pivoting sprayface having a plurality of spray openings, the plurality of spray openings including a first set of spray openings defining a first spray pattern and a second set of spray openings defining a second spray pattern, a first waterway fluidly connecting the diverter assembly to the first set of spray openings of the sprayface, and a second waterway fluidly connecting the diverter assembly to the second set of spray openings of the sprayface. The diverter assembly is configured to switch between the first and the second spray patterns by directing fluid to one of the first waterway and the second waterway. The at least one release mechanism is configured to selectively detach and attach the at least one audio assembly to the showerhead body.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The detailed description of the drawings particularly refers to the accompanying figures in which:

FIG. 1 is a front perspective view of an illustrative showerhead system of the present disclosure fluidly coupled to a water supply, showing an audio assembly attached to a showerhead assembly;

FIG. 2 is a rear perspective view of the showerhead system of FIG. 1, showing the audio assembly attached to the showerhead assembly;

FIG. 3 is a rear perspective view of the showerhead system of FIG. 1, showing the audio assembly detached from the showerhead assembly;

FIG. 4 is a cross-sectional view of the audio assembly of the showerhead system taken along line 4-4 of FIG. 2;

FIG. 5 is a cross-sectional view of the showerhead assembly taken along line 5-5 of FIG. 3;

FIG. 6 is a cross-sectional view of the interface between the audio assembly and the showerhead assembly of FIG. 3;

FIG. 7 is a cross-sectional view of the audio assembly taken along line 7-7 of

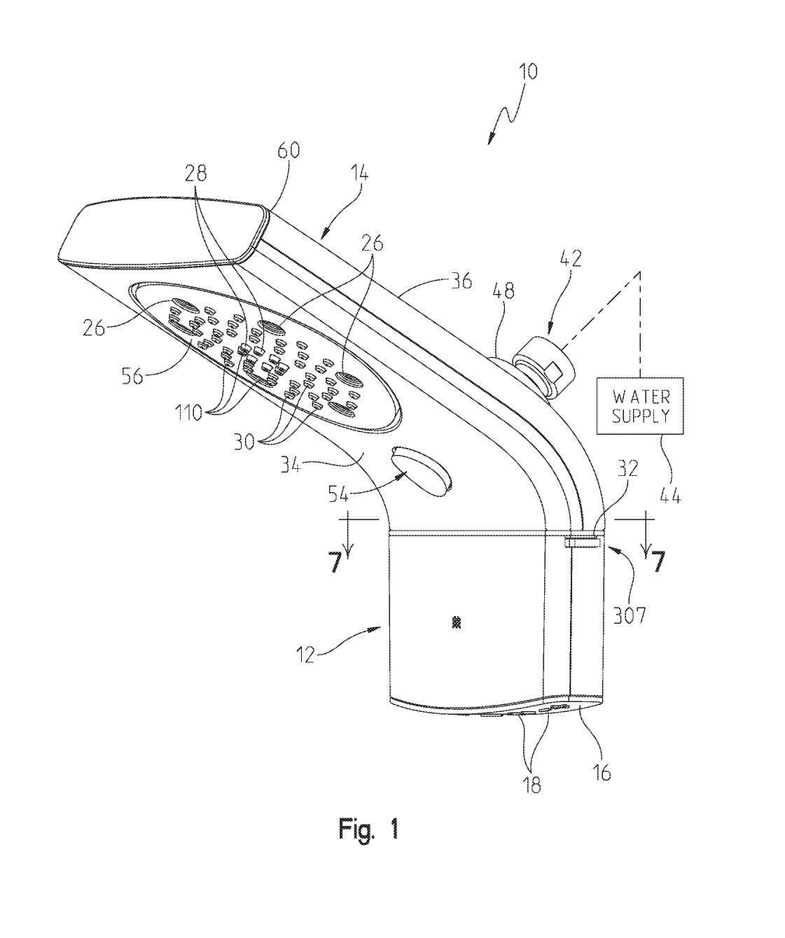

FIG. 1;

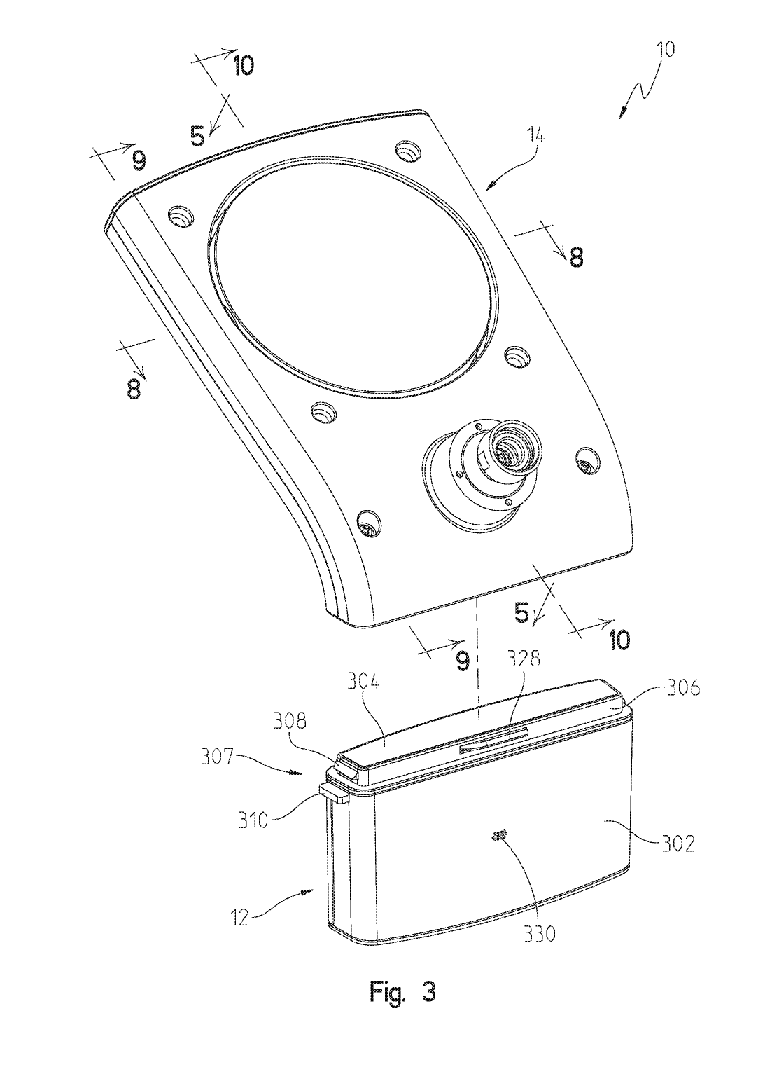

FIG. 8 is a front perspective view, in partial cross-section, of the sprayface and the waterways of the showerhead assembly of FIG. 3;

FIG. 9 is a rear perspective view, in partial cross-section, of the sprayface and waterways of the showerhead assembly of FIG. 3;

FIG. 10 is a cross-sectional view of the showerhead assembly taken along line 10-10 of FIG. 3;

FIG. 11 is a front perspective view of the showerhead system of FIG. 1, showing the audio assembly detached from the showerhead assembly; and

FIG. 12 is an exploded perspective view of the audio assembly and a distal end of the showerhead assembly of the showerhead system of FIG. 1.

### DETAILED DESCRIPTION OF THE DRAWINGS

The embodiments of the invention described herein are not intended to be exhaustive or to limit the invention to precise forms disclosed. Rather, the embodiments selected for description have been chosen to enable one skilled in the art to practice the invention.

Referring initially to FIG. 1, a showerhead system 10 of the present invention illustratively includes a showerhead assembly 14, a fluid connector 42, and an audio assembly 12 removable coupled to the showerhead assembly 14. Illustratively, the showerhead assembly 14 includes a diverter 54 and sprayface 56 supported by a body or housing 60 defining rectangular bottom recess 32 configured to removably receive the audio assembly 12.

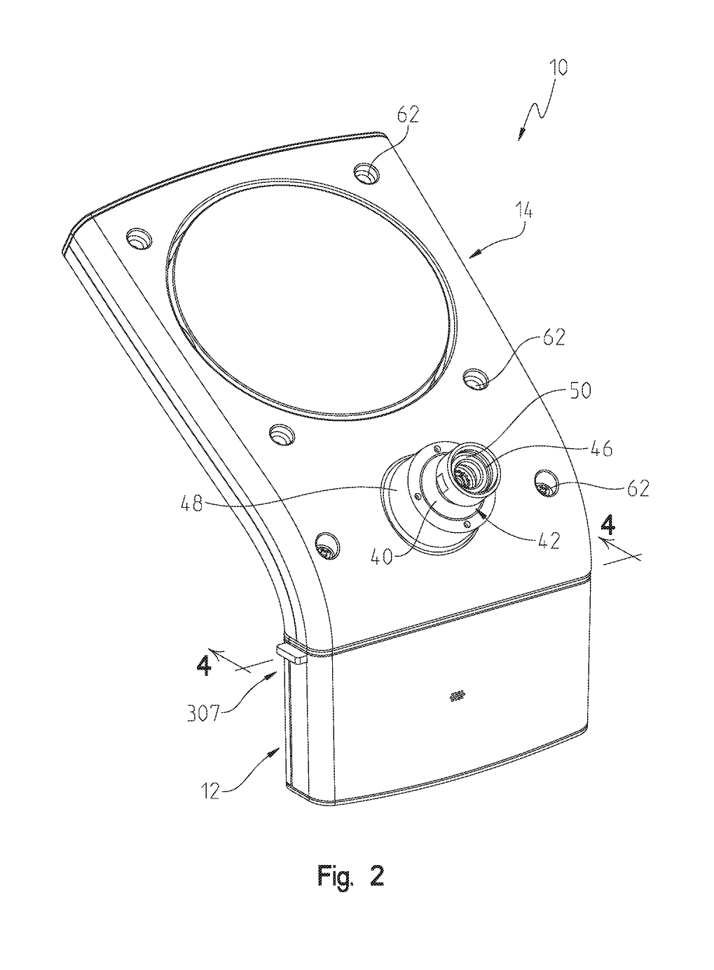

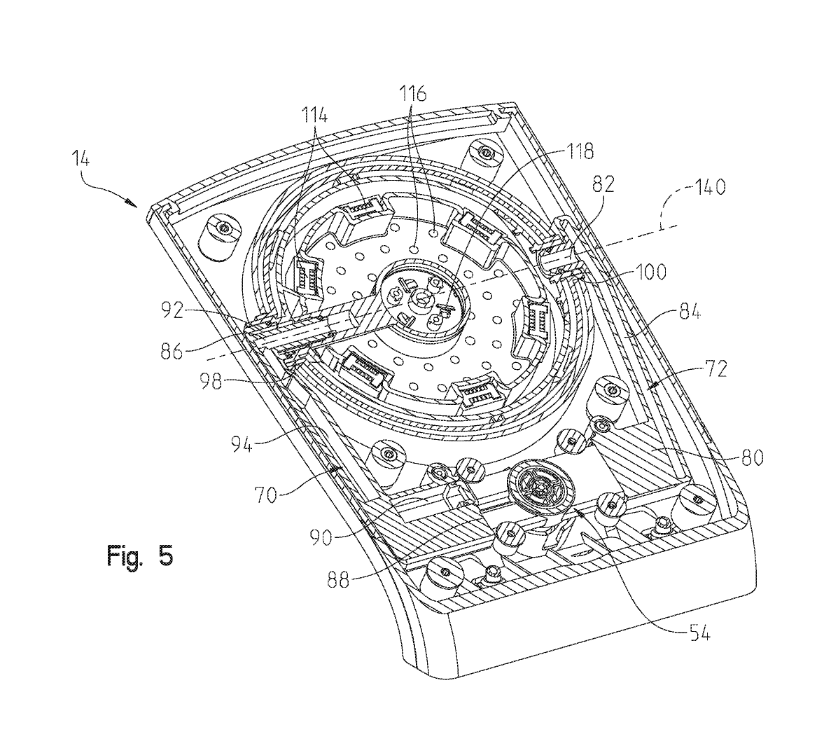

Housing 60 may be circular or any other shape, and is illustratively formed of a polymer. The housing 60 illustratively includes a front portion 34 coupled to a back portion 36 by a plurality of screws 62 (FIG. 2). In alternative embodiments, the screws 62 may be replaced by other fastening means, such as ultrasonic welding and adhesives. The sprayface 56 is illustratively supported for pivoting movement relative to the front portion 34. A fluid connector 42 is connected on the back portion 36 of the housing 60. The sprayface 56 is configured to pivot about first and second pivot points 98 and 100 extending along a pivot axis 140 extending parallel to the sprayface 56 (FIG. 5).

A conventional water supply 44 supplies water to the showerhead assembly 14. Water supply 44 is fluidly coupled to the showerhead assembly 14 through fluid connector 42. As shown in FIG. 2, fluid connector 42 illustratively includes a shower ball 40, and a screw ring 52 received between a ball washer 50 and a ball connector 48. Shower ball 40 permits rotational movement of the showerhead assembly 14 about orthogonal axes. Internal threads 46 in the shower ball 40 facilitate connection to the external threads of a pipe or riser supported by the shower wall (not shown). A flow restrictor may be fluidly coupled to the fluid connector 42 to limit the flow rate of water from the water supply 44 into the showerhead assembly 14 (FIG. 1).

Referring further to FIG. 1, the pivoting sprayface 56 illustratively includes a plurality of openings or ports 26, 28, 30 defining a first spray pattern and a second spray pattern. As shown in FIG. 5, a first spray pattern of openings 26 is fluidly connected to the diverter 54 through second waterway 72. Similarly, second and third spray pattern of openings 28 and 30 are fluidly connected to the diverter 54 through first waterway 70.

With reference to FIGS. 5, 8 and 9, the first waterway 70 and the second waterway 72 may each be a single waterway assembly or a dual waterway assembly. Single waterway assembly 72 illustratively includes a first inlet 80 fluidly connected to the diverter 54, a first outlet 82 fluidly connected to the plurality of spray openings 26, and a first passage 84 therebetween. Dual waterway assembly 70 illustratively includes a first passage 94 fluidly connecting a first inlet 90 and a first outlet 86, and a second passage 96 fluidly connecting a second inlet 88 and a second outlet 92. The first and the second inlets 90 and 88 of the dual waterway assembly 70 are fluidly connected to the diverter 54. Each of the first and the second outlets 86 and 92 of the dual waterway assembly 70 are fluidly connected to one of the plurality of spray pattern openings 28 and 30. Illustratively, the outlets 82, 86 and 92 are all aligned along the pivot axis 140 of the sprayface 56.

In one illustrative embodiment, both the first waterway 70 and the second waterway 72 may be single waterway assemblies. Similarly, in another illustrative embodiment, the first waterway 70 and the second waterway 72 may both be the dual waterway assemblies. In the illustrative embodiment shown in FIGS. 5, 8 and 9, the first waterway 70 is a dual waterway assembly, while the second waterway 72 is a single waterway assembly.

In the illustrative embodiment of FIG. 1, the pivoting sprayface 56 includes three spray patterns, namely: a plurality of fluid device ports 26, a plurality of massage ports 28, and a plurality of spray ports 30. Fluid device ports 26 are further illustrated, for example, in U.S. Patent Application Publication. No. 2013/0299608 to Spangler et al., the disclosure of which is expressly incorporated herein by reference.

With further reference to FIGS. 1 and 5, the first waterway 70 is fluidly connected to the plurality of massage ports 28, and the plurality of spray ports 30, and second waterway 72 is fluidly connected to the plurality of fluid device ports 26. More particularly, the first passage 94 of the first waterway 70 is fluidly connected to the massage ports 28, and the second passage 96 is fluidly connected to the spray ports 30. The first passage 84 of the second waterway 72 is fluidly connected to the fluidic device ports 26. In other illustrative embodiments, the first waterway 70 and the second waterway 72 and plurality of spray ports 26, 28, and 30 may be connected differently without affecting functionality of the present disclosure.

Pivoting sprayface 56 may have a circular shape (as shown) or any other shape. The pivoting sprayface 56 includes a plurality of projections or bosses 110 associated with openings 26, 28 and 30, defining chambers 112 to receive a plurality of fluidic devices 114, 116 and 118. For example, the fluidic devices 114 may comprise multi-dimensional fluidic devices or chips for providing multi-dimensional spray patterns, while fluidic devices 116 and 118 may comprise spray nozzles.

Referring further to FIG. 1, the diverter 54 may be a pen click diverter assembly (as shown), a toggle switch diverter (not shown), a rotary switch diverter (not shown), or any other type of switch diverter which is capable of diverting the inlet water from the water supply 44 to the ports 26, 28, 30 of the pivoting sprayface 56. In the illustrative embodiment, diverter 54 has at least four possible positions namely, a first position, a second position, a third position, and a fourth position. However, diverter 54 may be configured to include more or less than four positions.

In the first position, water flow is illustratively directed by the diverter 54 to the plurality of massage ports 28 via first inlet 80, through first passage 94 and first outlet 86. In the second position, water flow is illustratively directed by the diverter 54 to the plurality of spray ports 30 via second inlet 88, through second passage 96, and second outlet 92. In the third position, water flow is illustratively directed by the diverter to the plurality of fluid device ports 26 via first inlet 80, through first passage 84 and first outlet 82. In the fourth position, water flow may be obstructed such that water does not reach the pivoting sprayface 56. In other illustrative embodiments, the fourth position of the diverter 54 directs water flow to additional fluid device ports (not shown) in the pivoting sprayface 56, for example, via a second dual water waterway assembly (not shown) which replaces the second waterway 72.

Referring now to FIGS. 3, 11 and 12, the audio assembly 12 is shown in a detached position from the showerhead assembly 14. The audio assembly 12 illustratively includes a housing having a rear portion 302 and a front portion 402, a top wall 304 removably inserted into the showerhead assembly 14, a bottom portion or trim 16, and a release mechanism 307.

With further reference to FIGS. 3, 11 and 12, the release mechanism 307 illustratively includes a release button 310 on one of the rear portion 302 (as shown) or the front portion 402. As further detailed herein, the release mechanism 307 is configured to selectively detach and attach the audio assembly 12 to the showerhead housing 60. In certain illustrative embodiments, a magnetic coupling may be used in connection with the release mechanism 307 to assist in securing the audio assembly 12 to the showerhead assembly 14.

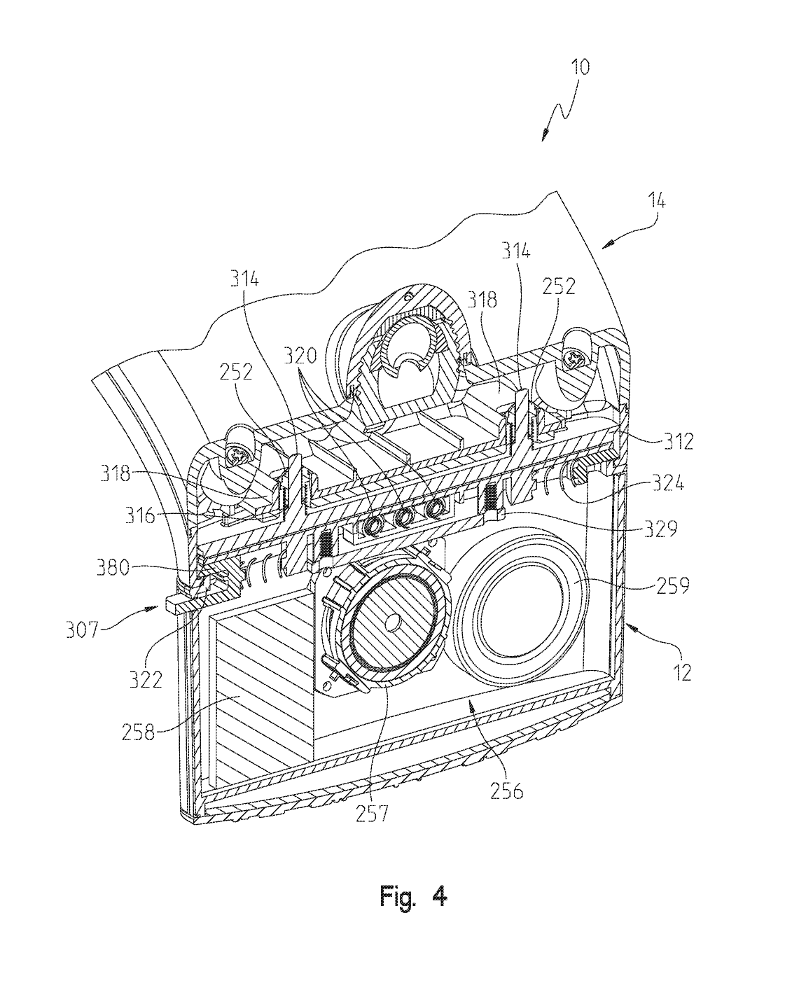

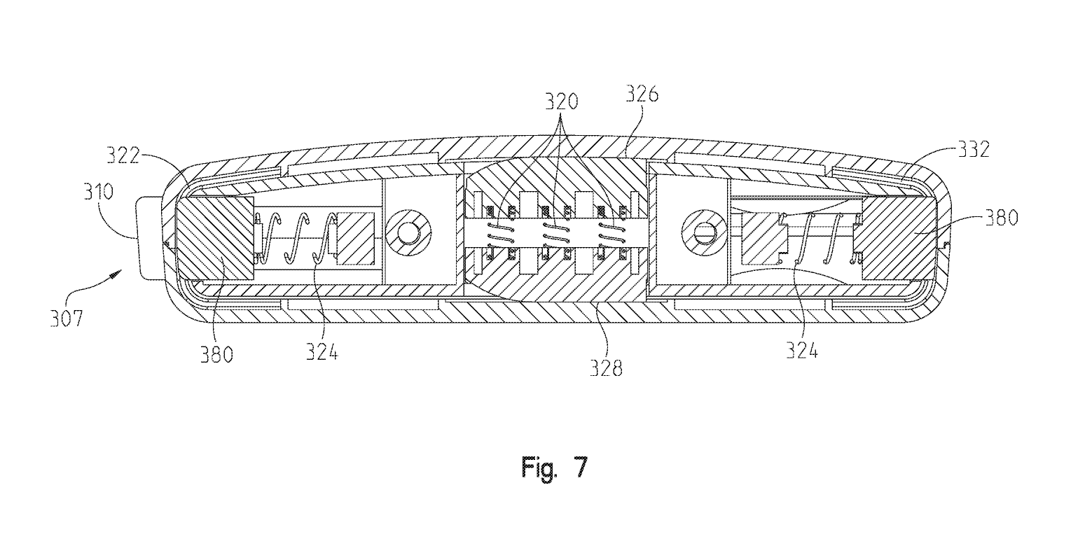

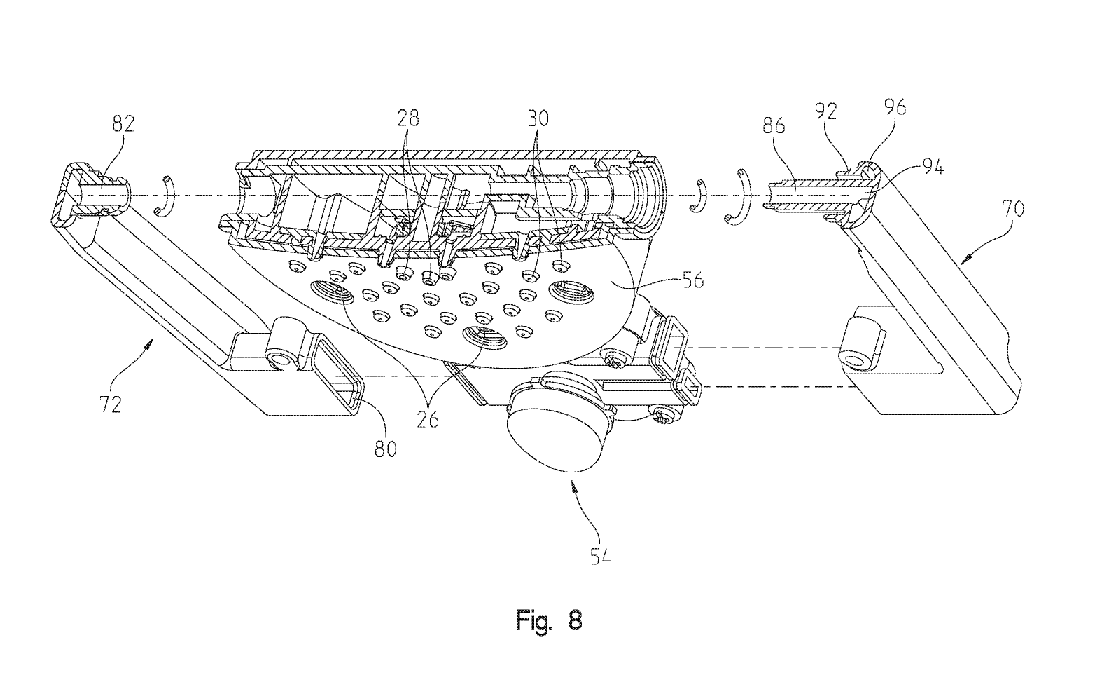

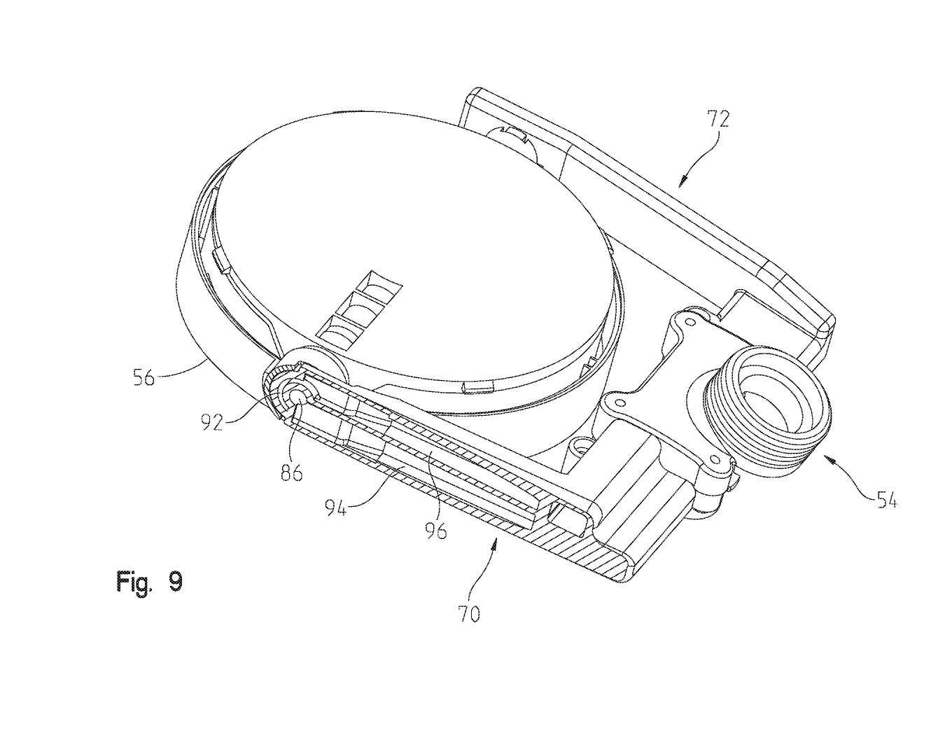

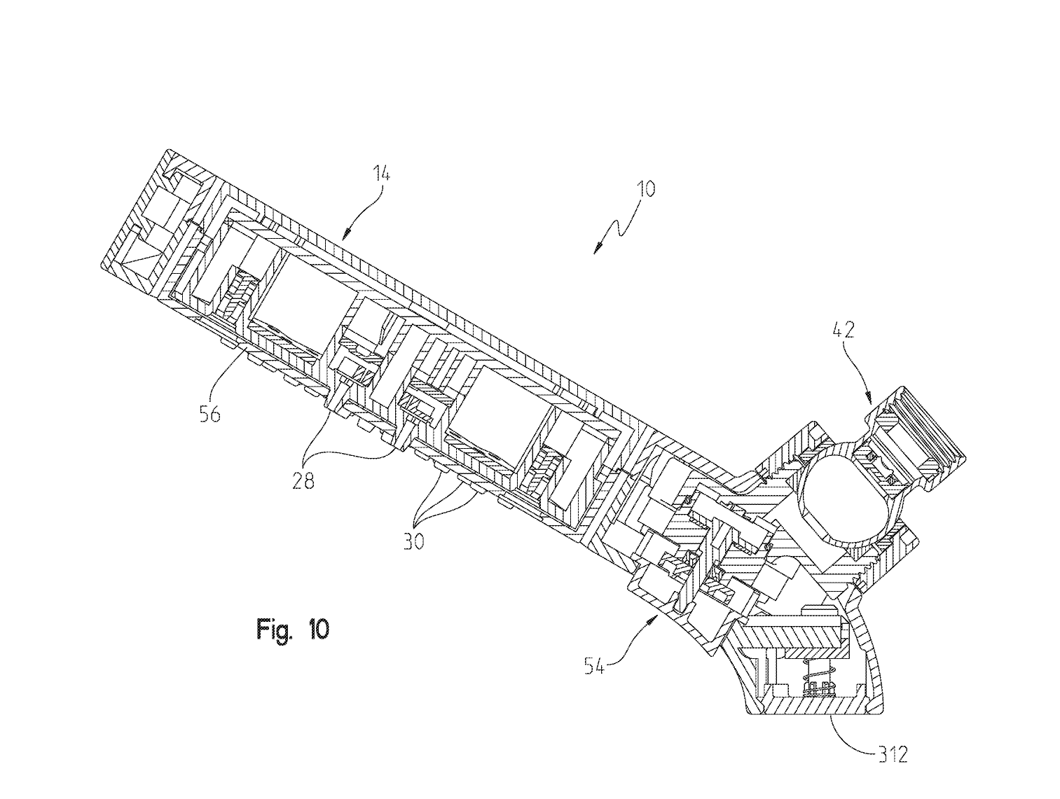

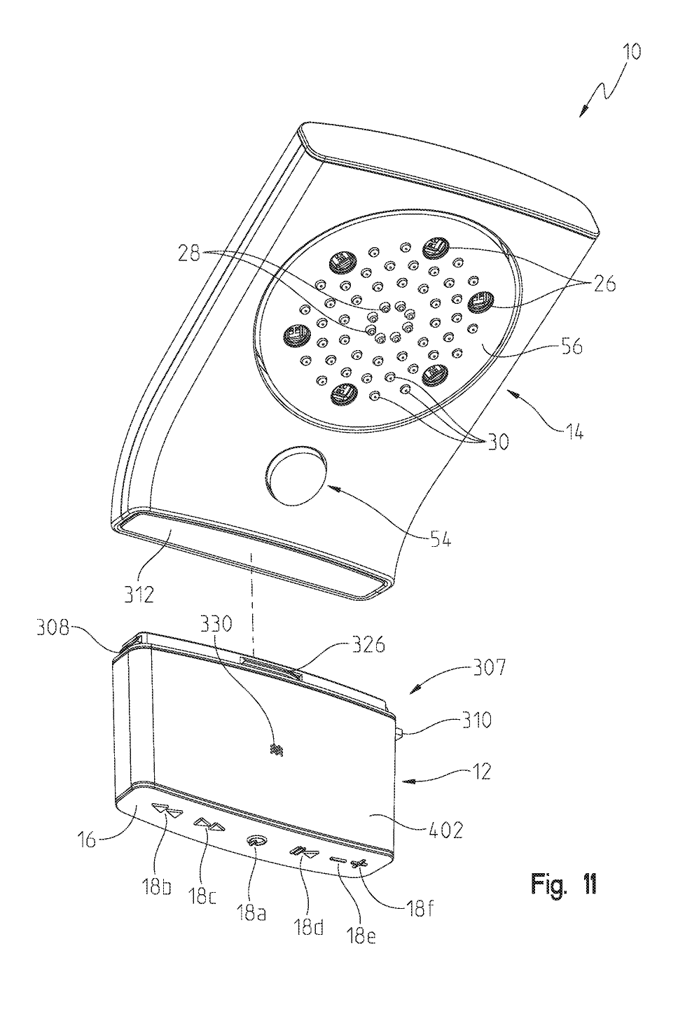

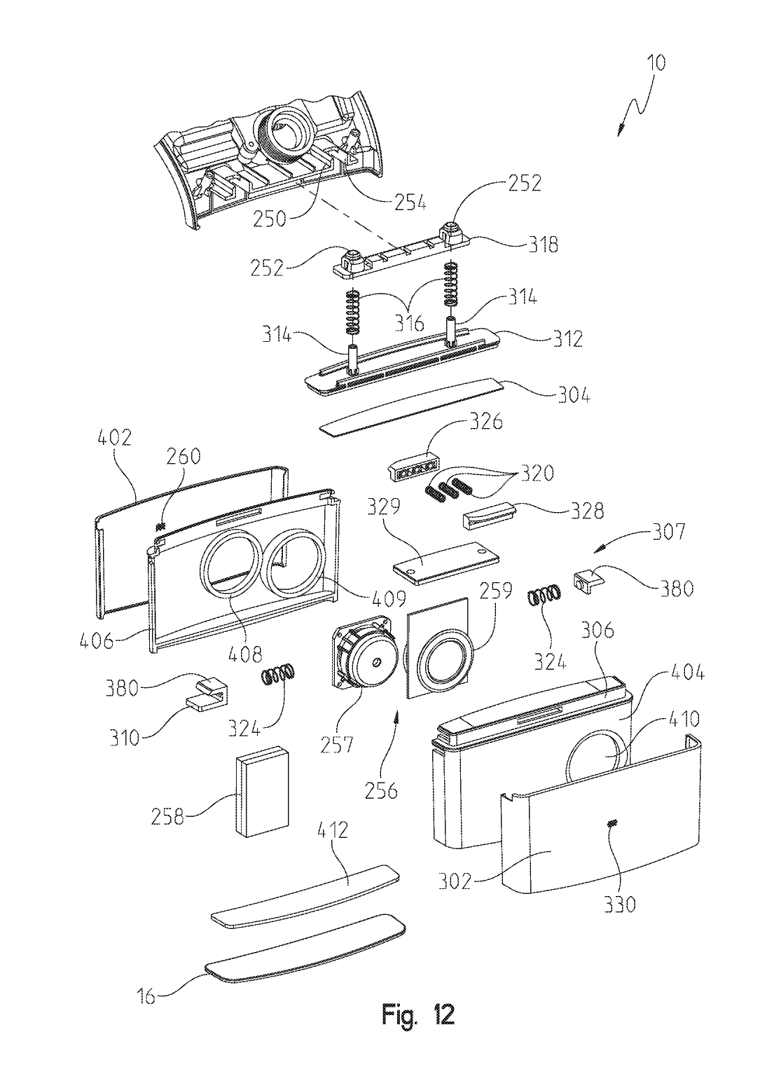

Top wall 304 of the audio assembly 12 illustratively has a step portion 306 that inserts into the showerhead assembly 14 and includes a plurality of side snaps 308. The top wall 304 further includes a front snap 326, and a rear snap 328 coupled to the front snap 326 by a plurality of springs 320 (FIGS. 4 and 12). Generally, the rear snap 328 and the front snap 326 may be two separate components coupled together (FIGS. 7 and 12) or one component capable of the same function. The plurality of springs 320 pushes the front snap 326 and the rear snap 328 outwardly such that the front and the rear snaps 326 and 328 protrude from an outer surface of the top wall 304 (FIGS. 3 and 11). A cover 329 is positioned below the snaps 326 and 328 and the springs 320.

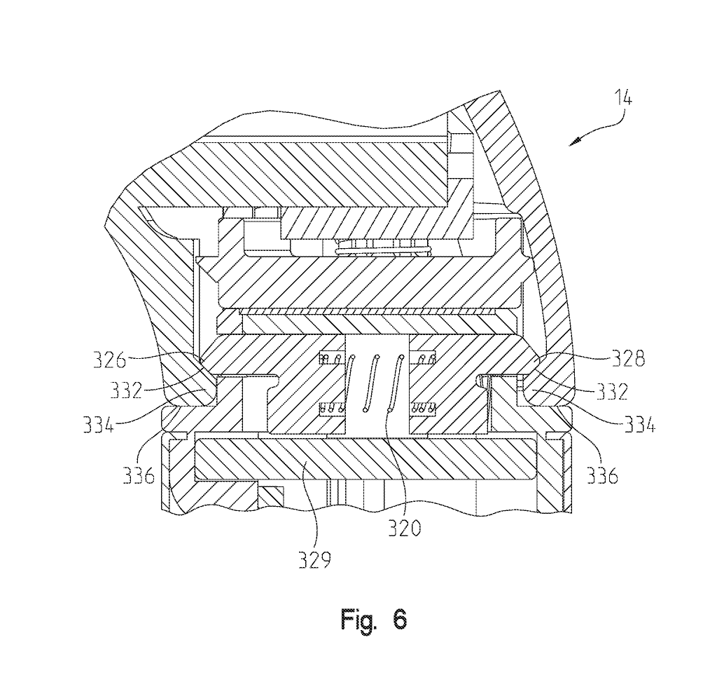

Now referring to FIGS. 6 and 12, the showerhead assembly 14 illustratively includes a protrusion 334 having a bottom surface 336 and a mating surface 332. The bottom surface 336 has an angle relative to an angle of a top surface of the front and rear snaps 326 and 328 such that upon application of a small force, the audio assembly 12 slides into the distal end of the showerhead assembly 14. Additionally, the mating surface 332 also has an angle relative to an angle of a bottom surface of the front and rear snaps 326 and 328 such that when the audio assembly 12 is pulled away from the showerhead assembly 14, the front and rear snaps 326 and 328 slide out. Additionally, in an assembled configuration, the mating surface 332 supports the front snap 326 and the rear snap 328. The plurality of snaps 326, 238, 308 have an angle relative to a mating surface of the showerhead assembly 14 with nominal interference for stability. Due to this angle relative to the mating surface, the audio assembly 12 attaches to the showerhead assembly 14 by applying a small amount of force in an upward direction.

The showerhead assembly 14 includes a flat shoulder 322 for each of the plurality of side snaps 308. Side snaps 308 rests on shoulders 322 of the showerhead assembly 14 when the audio assembly 12 is attached to the showerhead assembly 14. Mating surface 332 and shoulders 322 may have different angles or similar angles.

As shown and detailed herein, the showerhead assembly 14 includes angled surfaces for the front and rear snaps 326 and 328 to engage, and flat shoulders 322 for the side snaps 308 to engage. In other words, the side snaps 308 have positive locking features (with the showerhead assembly 14) that can only be removed using the release button 310, while the front and rear snaps 326 and 328 may be disengaged without a release button.

In an attached configuration, step portion 306 is not visible (FIG. 1), and a cover 312 of the showerhead assembly 14 is in a first position, such that the cover 312 is pushed further into the showerhead assembly 14 (FIG. 4). Cover 312 has a distal end and a proximal end having a plurality of protrusions 314 inserted into a fixed base 318 of the showerhead assembly 14. Fixed base 318 includes openings 252 aligned with, and slidably receiving, the plurality of protrusions 314. The protrusions 314 and openings 252 cooperate to guide the cover 312 to prevent binding during movement. Springs 316 are positioned on at least a portion of the protrusions 314. The showerhead assembly 14 includes a cover holder 250 having openings 254 aligned with protrusions 314. Fixed base 318, together with spring 316 and cover 312, is positioned into the cover holder 250 of the showerhead assembly 14 (FIG. 12).

To detach the audio assembly 12 from the showerhead assembly 14, release button 310 is pressed. When a force applied on the release button 310 is greater than the force exerted by the spring 324, the associated side snap 380 moves inwards, detaching the same side of the audio assembly 12 from the showerhead assembly 14. The opposite side snap 208 disengages by rotating the audio assembly 12 downward. As audio assembly 12 is moved away from the showerhead assembly 14, the front snap 326, the rear snap 328, and the opposite side snap 208 slides out of the showerhead assembly 14 due to a nominal interference between the angled surfaces of the showerhead assembly 14 and the audio assembly 12. The front, rear and opposing side snap 208 can disengage without a release button due to the angled interface surface of the showerhead assembly 14. Additionally, as the audio assembly 12 moves away from the showerhead assembly 14, and due to the force exerted by the springs 316 onto the cover 312, cover 312 releases to a second position (FIGS. 10 and 11) such that cover 312 covers a distal end of the showerhead assembly 14. In the second position, the cover 312 is flush with the distal end of the showerhead assembly 14.

Referring back to FIG. 1, bottom trim 16 of the audio assembly 12 is configured to support the audio assembly 12 on another surface, for example, a table. Bottom trim 16 includes control buttons 18 to control various audio features of the audio assembly 12. With reference to FIG. 11, the control buttons 18 may include a power button 18a, a rewind button 18b, a fast forward button 18c, a pause/play button 18d, a volume decrease button 18e, and a volume increase button 18f. Referring now to FIG. 12, the audio assembly 12 further includes a front casing 406 and a rear casing 404 which couples with the front portion 402 and the rear portion 302, respectively.

With reference to FIGS. 4 and 12, the audio assembly 12 further includes at least one speaker 256 and a battery 258, both positioned within the audio assembly 12. The at least one speaker 256 illustratively includes an active driver 257 and a passive radiator 259. The front casing 406 includes a first opening 408 configured to position the active driver 257. The front casing 406 may also include a second opening 409 configured to position the passive radiator 259 facing the front casing 406 (as shown). Similarly, the rear casing 404 illustratively includes an opening 410 configured to position the passive radiator 259.

The illustrative audio assembly 12 also includes a bottom casing 412 which couples to the bottom trim 16. Rear portion 302 may include openings 330 aligned with the at least one speaker 256 (FIG. 3). Similarly, front portion 402 may include openings 260 aligned with the at least one speaker 256 (as shown on FIG. 12). Audio assembly 12 further illustratively includes a charging socket (not shown) for charging the battery 258. The audio assembly 12 is configured to wirelessly receive audio data from at least one other device; for example, a cellular phone, a computer, and a tablet. Such wireless communication may include receiving data from a Wi-Fi network or Bluetooth connection.

Although the invention has been described in detail with reference to certain preferred embodiments, variations of modifications exist within the spirit and scope of the invention as described and defined in the following claims.

1. A showerhead comprising:
a diverter assembly;
a housing supporting a pivoting sprayface having a plurality of spray openings, the plurality of spray openings including a first set of spray openings defining a first spray pattern and a second set of spray openings defining a second spray pattern;
a first waterway fluidly connecting the diverter assembly to the first set of spray openings of the sprayface;
a second waterway fluidly connecting the diverter assembly to the second set of spray openings of the sprayface; and
an audio assembly releasably coupled to the housing;
wherein the diverter assembly is configured to switch between the first and the second spray patterns by directing fluid to one of the first waterway and the second waterway.

2. The showerhead of claim 1, wherein at least one of the first waterway and the second waterway is a single waterway, the single waterway including a first single inlet, a first single outlet, and a first passage fluidly connecting the first single inlet and the first single outlet.

3. The showerhead of claim 1, wherein at least one of the first waterway and the second waterway is a dual waterway, the dual waterway including:
a first inlet,
a second inlet,
a first outlet,
a second outlet,
a first passage fluidly connecting the first inlet and the first outlet, and
a second passage fluidly connecting the second inlet and the second outlet;
wherein the first and the second outlets are concentric with each other.

4. The showerhead of claim 1, wherein the diverter assembly is one of a rotary switch, a push button, a slide switch and a toggle switch configured to switch between the first spray pattern and the second spray pattern.

5. The showerhead of claim 1, wherein an interface between the pivoting sprayface and each of the first and the second waterways further includes a stop configured to limit an angular range of motion of the pivoting sprayface.

6. The showerhead of claim 1, wherein the audio assembly includes at least one speaker and at least one release mechanism configured to selectively detach and attach the at least one audio assembly to the housing.

7. A showerhead comprising:
an audio assembly including:
at least one speaker;
a plurality of control buttons configured to adjust at least one of a plurality of audio features;
a battery; and
at least one release mechanism; and
a showerhead body;
wherein the at least one release mechanism is configured to selectively detach and attach the at least one audio assembly to the showerhead body.

8. The showerhead of claim 7, wherein the audio assembly further includes a charging socket configured to charge the battery.

9. The showerhead of claim 7, wherein the audio assembly further includes a bottom surface configured to support the audio assembly when the audio assembly is detached from the main assembly.

10. The showerhead of claim 7, wherein the audio assembly is configured to receive data wirelessly from at least one other device.

11. The showerhead of claim 7, wherein the audio assembly further includes an outer surface, a release button, and a plurality of side snaps, wherein release button and a plurality of side snaps are positioned on the outer surface.

12. The showerhead of claim 11, wherein at least one of the side snaps has an angle relative to a mating surface of the showerhead body with nominal interference for stability.

13. The showerhead of claim 7, wherein the showerhead body further includes a first end and a second end, a cover positioned at the second end, wherein the cover moves between a first positon and a second position, wherein in the first position the cover is pushed towards the first end and the audio assembly is attached to the showerhead body, and wherein in the second position the cover is biased towards the second end and the audio assembly is detached from the showerhead body.

14. The showerhead of claim 13, wherein the cover is flush with the second end of the showerhead body when in the second position.

15. The showerhead of claim 7, wherein the showerhead body includes:
a diverter assembly,
a pivoting sprayface having a plurality of spray openings, the plurality of spray openings including a first set of spray openings defining a first spray pattern and a second set of spray openings defining a second spray pattern;
a first waterway fluidly connecting the diverter assembly to the first set of spray openings of the sprayface; and
a second waterway fluidly connecting the diverter assembly to the second set of spray openings of the sprayface; and
wherein the diverter assembly is configured to switch between the first and the second spray patterns by directing fluid to one of the first waterway and the second waterway.

16. A showerhead system, comprising:
an audio assembly including:
at least one speaker;
a plurality of control buttons configured to adjust at least one of a plurality of audio features;
a battery; and
at least one release mechanism; and
a showerhead body, including:
a diverter assembly,
a pivoting sprayface having a plurality of spray openings, the plurality of spray openings including a first set of spray openings defining a first spray pattern and a second set of spray openings defining a second spray pattern;
a first waterway fluidly connecting the diverter assembly to the first set of spray openings of the sprayface;
a second waterway fluidly connecting the diverter assembly to the second set of spray openings of the sprayface;
wherein the diverter assembly is configured to switch between the first and the second spray patterns by directing fluid to one of the first waterway and the second waterway; and
wherein the at least one release mechanism is configured to selectively detach and attach the audio assembly to the showerhead body.
